(19) United States
(12) Patent Application Publication
(10) Pub. No.: US 2006/0268197 A1
(43) Pub. Date: Nov. 30, 2006

(54) Combination full color and monochrome reflective display

(76) Inventors: George T. Valliath, Winnetka, IL (US); Zili Li, Barrington, IL (US)

Correspondence Address: MOTOROLA, INC., 1303 EAST ALGONQUIN ROAD, IL01/3RD, SCHAUMBURG, IL, 60196, US

(21) Appl. No.: 11/141,122

(22) Filed: May 31, 2005

(51) Int. Cl. G02F 1/1335

(52) U.S. Cl. 349/96

(57) ABSTRACT

A cell of a combination full color and monochromatic display comprises a first polarizer, a second polarizer and an optical switching cell. The optical switching cell is positioned between the first polarizer and the second polarizer and is operable to alter the polarization of transmitted light. A backlight emits light that is incident upon the second polarizer. A hologram positioned between the backlight element and the second polarizer reflects a portion of an ambient light incident upon the hologram. The display may be operated in a first mode, for which the backlight elements emits light of a plurality of colors, and a second mode for which the backlight emits light of at most one color.

### FIELD

This invention relates generally to the field of visual displays for electronic devices and the like.

### BACKGROUND

Many cellular radio telephones have color displays that use a transflective color liquid crystal display (LCD). The operation of an LCD is a compromise between power consumption and optical performance.

Currently, the best optical performance is achieved by a field sequential transmissive display that has an always-on backlight. This type of display has a wide color gamut (wider than the typical display of a portable or laptop computer display) and high resolution (nine times the resolution of a typical portable computer display). However, the power consumption of this type of display is approximately 80 times that of a reflective display. This type of display cannot be used continuously on a cellular telephone.

The best reflective display, in terms of brightness, is the monochrome holographic display. However, such displays only provide monochrome operation.

### BRIEF DESCRIPTION OF THE DRAWINGS

The novel features believed characteristic of the invention are set forth in the appended claims. The invention itself, however, and further objects and advantages thereof, will best be understood by reference to the following detailed description of an illustrative embodiment when read in conjunction with the accompanying drawing(s), wherein:

FIG. 1 is a diagram of a cell of a combination color and monochrome display in accordance with certain embodiments of the invention.

FIG. 2 is a graph showing optical brightness as a function of wavelength for a combination color and monochrome display, in accordance with certain embodiments of the invention.

FIG. 3 is a diagram of a combination color and monochrome display comprising an array of cells, in accordance with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

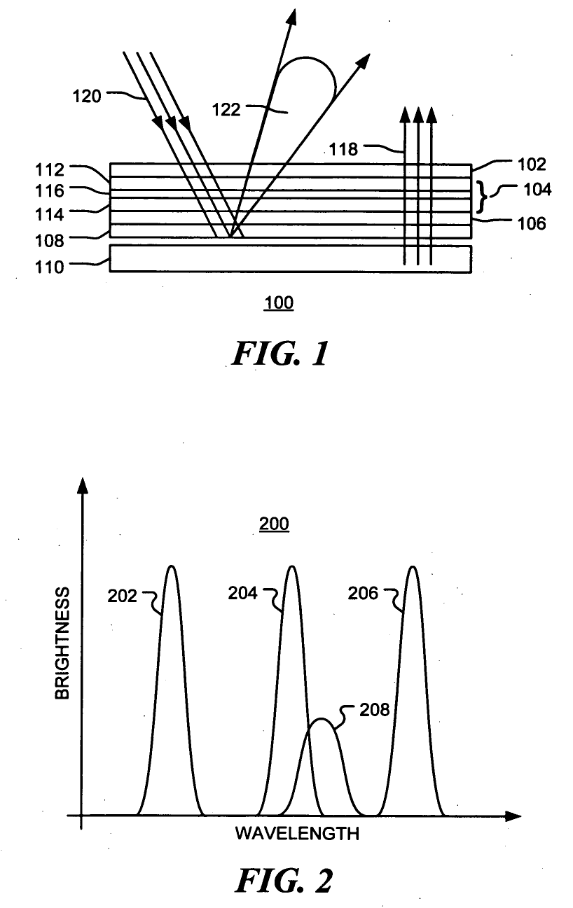

FIG. 1 is a diagram of a cell of a combination color and monochrome display in accordance with certain embodiments of the invention. Referring to FIG. 1, the display cell 100 comprises a first polarizer 102, a liquid crystal cell 104, a second polarizer 106, a hologram 108 and a backlight 110. The liquid crystal cell 104 together with the first polarizer 102, second polarizer 106 and backlight 110 form a liquid crystal display (LCD) cell. In one embodiment of the invention the LCD cell is a super-twist nematic (STN) cell, but other types of LCD cells may be used. The liquid crystal cell 104 may comprise two bounding plates, 112 and 114, usually glass plates, each with a transparent conductive coating (such as indium tin oxide), which acts as an electrode, and an alignment coating. A liquid crystal material 116, such as a nematic liquid crystal, fills the gap between the two bounding plates. In this embodiment the cell 104 employs a liquid crystal to alter the polarization of light passing through it, however alternative optical switching cells that alter the polarization of light may be used as equivalents.

In one embodiment of the invention, the backlight 110 is a field sequential backlight comprising red, green and blue (RGB) light emitting diodes (LED's). In operation, the RGB LED's may be turned on sequentially to provide a white light 118 that is synchronized with the liquid crystal cell 104. In operation, the light 118 is passed or blocked by the liquid crystal cell 104.

The hologram 108 is attached to the second polarizer 106 of the LCD cell 100. In operation, the hologram 108 reflects incident ambient light 120. The viewing cone 122 of the hologram is constrained to be narrow and is aligned in a preset direction.

In a further embodiment, a photo-sensor is incorporated into the display to provide for automatic adjustment of the backlight to maintain a desired color gamut.

FIG. 2 is a graph showing optical brightness of light emitted from an exemplary display cell as a function of optical wavelength. FIG. 2 shows the blue LED emission peak 202, the green LED emission peak 204, and the red LED emission peak 206. The wavelength of the hologram reflection peak 208 is chosen to be misaligned with the wavelengths of the LED emission peaks 202, 204 and 206. Hence, the hologram is substantially transparent to the LED backlight.

The display may be operated in ‘color mode’ or in a ‘monochrome mode’. In the color mode of operation, the backlight is ‘on’. In this mode, the light from the backlight passes through the hologram and emerges from the display unaffected by the hologram. In the monochrome mode of operation, the backlight is ‘off’. In this mode, the hologram reflects a portion of the ambient light. There are no color filters in the liquid crystal cell or the polarizers, so the display is as bright as conventional holographic monochrome displays. Further, as the hologram is close to the liquid crystal cell, a high monochrome resolution can be achieved.

A combination color and monochrome display comprises multiple display cells arranged in an array pattern. Each cell provides a pixel element for the display. A combination color and monochrome display may be used in a variety of applications. In particular, a combination color and monochrome display may used in a user interface for a portable electronic device, such as a cellular phone, personal digital assistant, digital audio/video player, digital image viewer, gaming device or digital camera. Such devices often have both text and graphic modes. For example, a digital media player may show lists of songs in a text mode and show digital photographs in a graphic mode. The display of the present invention may be operated in the color mode to display high gamut color images and then switched to a high-brightness monochrome mode to display text for songs lists etc. In another example, a cellular telephone may display a vivid color images when initially turned on and then fade into a high brightness monochrome color. The monochrome mode of operation is suitable for many telephone operations. The display may also be used for non-portable electronic devices.

The display will consume less power when in operated in the monochrome mode compared with the color mode. For electronic devices where a monochrome mode is suitable for a substantial period of the operating time, the use of a combination color and monochrome display will result in significantly less power consumption. This, in turn, will lead to a longer battery life.

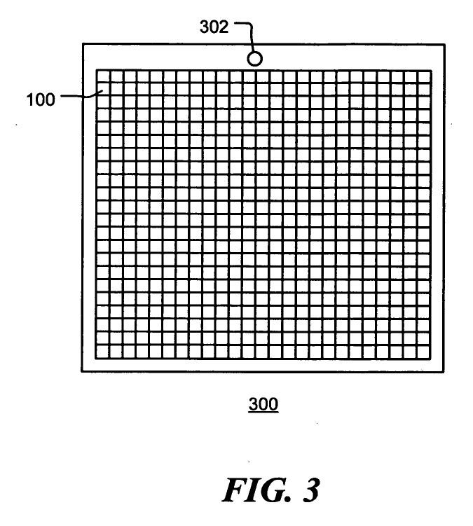

FIG. 3 is a diagram of a combination color and monochrome display comprising an array of cells in accordance with certain embodiments of the invention. The display 300 comprises a number of cells 100 arranged in a pattern. In this embodiment a photo-sensor 302 is positioned to detect the level of ambient light incident upon the display. For operation in low ambient light levels, a backlight LED, such as the green LED, may be turned on to provide an auxiliary backlight. The photo-sensor 302 may be used to measure ambient brightness and adjust backlight output to maintain a minimum gamut. In high light levels, such as sunlight, the backlight can be switched off.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A combination full color and monochromatic display comprising a pattern of one or more cells, a cell of the display comprising:
a first polarizer;
a second polarizer;
an optical switching cell positioned between the first polarizer and the second polarizer, the optical switching cell being operable to alter the polarization of transmitted light;
a backlight element operable to emit light incident upon the second polarizer; and
a hologram positioned between the backlight element and the second polarizer to reflect a portion of an ambient light incident upon the hologram, wherein the display is operable in a first mode for which the backlight element emits light of a plurality of colors, and a second mode for which the backlight element emit light of at most one color.

2. A combination full color and monochromatic display in accordance with claim 1, wherein the optical switching cell is a liquid crystal cell.

3. A combination full color and monochromatic display in accordance with claim 1, wherein the optical switching cell is a super-twist nematic liquid crystal cell.

4. A combination full color and monochromatic display in accordance with claim 1, wherein the backlight element comprises red, green and blue light emitting diodes operable sequentially and in synchrony with the optical switching cell.

5. A combination full color and monochromatic display in accordance with claim 4, wherein the hologram reflects light in wavelength range that is misaligned with wavelength ranges of the red, green and blue light emitting diodes.

6. A combination full color and monochromatic display in accordance with claim 1, further comprising a photo-sensor, operable to detect a level of ambient light incident upon the display.

7. A combination full color and monochromatic display in accordance with claim 6, wherein, in the monochromatic mode of operation, the backlight emits a monochromatic light at a power dependent upon the level of ambient light incident upon the display.

8. A combination full color and monochromatic display in accordance with claim 6, wherein, in the monochromatic mode of operation, the backlight is turned off when the level of ambient light incident upon the display is above a preset level.

9. A combination full color and monochromatic display in accordance with claim 1, wherein, in the monochromatic mode of operation, the backlight is turned off.

10. An electronic device incorporating a combination full color and monochromatic display in accordance with claim 1.

11. A combination full color and monochromatic display comprising:
an optical switching means having an adjustable optical transmissibility;
a light emitting means operable to emit light of a plurality of colors; and
a light reflecting means positioned between the light source and optical switching cell and operable to reflect light;
wherein the light reflecting means is substantially transparent to light emitted by the light emitting means.

12. A combination full color and monochromatic display in accordance with claim 11, wherein the optical switching means comprises a liquid crystal switching cell.

13. A combination full color and monochromatic display in accordance with claim 11, wherein light reflecting means comprises a hologram.

14. A combination full color and monochromatic display in accordance with claim 11, wherein light emitting means comprises red, green and blue light emitting diodes.

15. A combination full color and monochromatic display in accordance with claim 11, wherein the display is operable in a first mode, for which the light emitting means emits light of a plurality of colors, and a second mode for which the light emitting means emits light of at most one color.

16. A combination full color and monochromatic display in accordance with claim 11, further comprising:
a photo sensor operable to sense a level of ambient light incident upon the display; and
means to adjust the level of light emitted from the light emitting means in response to the level of ambient light.

17. A method for operating a combination full color and monochromatic display, comprising:
if the display is to be operated in a full color mode of operation:
emitting light of a plurality of colors from a backlight;
transmitting the light through a hologram that is substantially transparent to the light of a plurality of colors; and
controlling an optical switch to selectively transmit or block the light of a plurality of colors;
if the display is to be operated in a monochrome mode of operation:
controlling an optical switch to selectively block ambient light incident upon the display or transmit the ambient light to a hologram; and
reflecting a portion of the ambient light from the hologram.

18. A method in accordance with claim 17, further comprising:
if the display is to be operated in a monochrome mode of operation:
sensing a level of ambient light incident upon the display; and
emitting monochromatic light from the backlight if the level of ambient light incident upon the display is low.

19. A method in accordance with claim 17, wherein controlling the optical switch comprises energizing a liquid crystal cell.

20. A method for reducing power consumption in an electronic device having a display operable in a full color mode of operation and a monochrome mode of operation, the method comprising:
operating the display of the electronic device in the full color mode of operation when the electronic device performs a function of a first set of functions; and
operating the display of the electronic device in the monochrome mode of operation when the electronic device performs a function of a second set of functions,
wherein the monochrome mode of operation of the display consumes less power than the full color mode of operation of the display.

21. A method in accordance with claim 20, wherein operating the display of the electronic device in the full color mode of operation comprises operating a full color field sequential backlight in synchrony with a liquid crystal display cell.

22. A method in accordance with claim 20, wherein operating the display of the electronic device in the monochrome mode of operation comprises reflecting ambient light from a hologram through a liquid crystal display cell.

23. A method in accordance with claim 20, wherein operating the display of the electronic device in the monochrome mode of operation comprises operating a monochrome field sequential backlight in synchrony with a liquid crystal display cell.
